(19) United States
(12) Patent Application Publication
(10) Pub. No.: US 2009/0120299 A1
(43) Pub. Date: May 14, 2009

(54) Line Pressure Brewer

(75) Inventors: Christopher W. Rahn, Virden, IL (US); Charles H. Clark, Chatham, IL (US)

Correspondence Address: BARNES & THORNBURG LLP, P.O. BOX 2786, CHICAGO, IL, 60690-2786, US

(73) Assignee: BUNN-O-MATIC CORPORATION, Springfield, IL (US)

(21) Appl. No.: 11/813,503

(22) PCT Filed: Jan. 4, 2006
(86) PCT No.: PCT/US06/00095

§ 371 Date: Oct. 3, 2007

Related U.S. Application Data
(60) Provisional application No. 60/641,814, filed on Jan. 6, 2005.

(51) Int. Cl. A47J 31/44

(52) U.S. Cl. 99/279

(57) ABSTRACT

A brewer (20) for brewing a beverage adapted to be coupled in fluid communication with a pressurized water line. The brewer includes a tank (70) having a chamber adapted to be placed in fluid communication with the pressurized water line and a spray head (40) in fluid communication with the tank (70). The spray head (40) is adapted to discharge water from the tank (70) for brewing a beverage. A fluid pressure regulator (50) provides a flow of water to the tank (70) and to the spray head (40) at a selected pressure. A dispensing valve (90) is provided in fluid communication with the tank (70) and the spray head (40) for selectively controlling the flow of water from the tank (70) to the spray head (40). A controller (26) is provided for controlling operation of the brewer Water flows through the tank (70) to the spray head (40) under pressure provided by the pressurized water line for brewing a beverage.

### RELATED APPLICATIONS

This application claims the benefit of U.S. Provisional Application 60/641,814, filed Jan. 6, 2005.

### BACKGROUND

A variety of brewing apparatus have been developed to combine heated water with a brewing substance such as ground coffee or tea material in order to infuse the material and produce a brewed beverage. There are many ways to combine the water with the brewing substance. One way is to place the substance in a filter device such as a disposable filter paper and place the filter paper and brewing substance in a brewing funnel or basket. Heated water is mixed with the brewing substance in the filter thereby allowing the brewed beverage to filter through the paper leaving the saturated brewing substance in the filter paper. The saturated substance and used filter paper can be thrown away.

Another way of brewing beverage is to encapsulate the brewing substance in a filter material. The brewing substance in the filter material provides a convenient package for handling a predetermined quantity of brewing substance. The filter material provides a package or container for the brewing substance. This package allows the brewing substance to be handled prior to brewing and after brewing without complication or mess.

Such brewing substances pre-packaged in filter material are referred to as “pods” or “sachets.” Pods can be compressed during packaging of the filter material or left in a generally loose condition. Pods generally have a circular shape with a generally flattened configuration often appearing as a disc or puck. Pods generally range in a size from approximately 45-60 millimeters and contain approximately 6-12 grams of brewing substance.

When brewing a beverage it is desirable to saturate, penetrate, agitate and otherwise engage all of the particles of the brewing substance so as to wash from the brewing substance the desirable flavor characteristic substances for incorporation into the brewed beverage. When brewing coffee in the traditional manner by gravity flow of water through the coffee grounds a key parameter is contact time between the water and the coffee. If the contact time is too low solubles are under-extracted and if the contact time is too high solubles are over-extracted. Even if the correct volume of water is used, an improper contact time can ruin the brewed beverage.

When it was first desired to brew a good quality, good tasting cup of coffee in under one minute, many coffee aficionados thought it impossible. However, it was determined that the introduction of a certain level of pressure to the water could facilitate brewing a good cup of coffee in this limited time. The extraction process was acceptable and the contact time problem was overcome with the addition of pressure to the water supply. Pumps were incorporated into pod brewers to provide pressurized water at pressures from approximately fifteen to approximately twenty-five pounds per square inch.

Pod brewers generally make small amounts of brewed beverage, typically four to twelve ounces, by pushing water under pressure through the pod of brewing substance, such as coffee. The water pressure is generally generated by a pump in the pod brewer. Such pumps are susceptible to wear, contamination, deposit build up, and other factors that affect their useful life in a pod brewer. Operation of the pump also generates undesirable noise and adds to the overall cost of the brewer.

### SUMMARY

A brewer for brewing a beverage. The brewer is adapted to be coupled in fluid communication with a pressurized water line. The brewer includes a tank having a chamber, an inlet, and an outlet. The inlet of the tank is adapted to be placed in fluid communication with the pressurized water line. The brewer may include a heating device associated with the tank for heating water within the chamber of the tank. The brewer includes a brewing assembly having a receptacle for the receipt of a brewing substance, and a spray head. The spray head is adapted to be in fluid communication with the outlet of the tank and is adapted to discharge water into the receptacle of the brewing assembly for brewing a beverage. The brewer may include a fluid pressure regulator including an inlet and an outlet. The inlet of the pressure regulator is adapted to be placed in fluid communication with the pressurized water line, and the outlet of the pressure regulator is adapted to be in fluid communication with the tank and the spray head. The fluid pressure regulator provides a flow of water through the outlet of the fluid pressure regulator to the tank and to the spray head at a selected pressure. The brewer may include a fluid flow device, such as a flowmeter or a flow control device, including an inlet and an outlet. The inlet of the fluid flow device is adapted to be placed in fluid communication with the pressurized water line and the outlet of the fluid flow device is adapted to be in fluid communication with the tank and the spray head. The fluid flow device determines the rate of flow at which water flows to the tank and to the spray head. The brewer may include a dispensing valve having an inlet and an outlet. The inlet of the dispensing valve is in fluid communication with the outlet of the tank and the outlet of the dispensing valve is in fluid communication with the spray head. The dispensing valve is adapted to selectively control the flow of water from the tank to the spray head.

The brewer may include a check valve having an inlet adapted to be placed in fluid communication with the pressurized water line and an outlet in fluid communication with the inlet of the tank. The check valve allows the flow of water from the pressurized water line to the chamber of the tank, and prevents the flow of water from the chamber of the tank through the inlet of the tank. The brewer may include an air pump in fluid communication with the spray head. The air pump is adapted to provide a flow of air to the spray head to purge water from the spray head and pod after brewing is complete. The brewer may include an inlet valve having an inlet adapted to be placed in fluid communication with the pressurized water line and an outlet in fluid communication with the inlet of the tank. The inlet valve is adapted to selectively allow fluid flow from the pressurized water line to the inlet of the tank. The brewer may include a controller in electrical communication with the dispensing valve, fluid flow device, fluid pressure regulator, and/or inlet valve to selectively control the operation thereof. The brewer may also include a water level sensor and a temperature sensor associated with the tank and electrically coupled to the controller. An expansion chamber may also be provided in fluid communication with the chamber of the tank. Water is adapted to flow from the tank to the spray head under pressure provided solely by the pressurized water line, without the use of any pumps or the like.

### BRIEF DESCRIPTION OF THE DRAWING FIGURES

FIG. 1 is a diagrammatic illustration of a brewer as set forth in the present disclosure.

FIG. 2 is a diagrammatic illustration of another embodiment of a brewer as set forth in the present disclosure.

FIG. 3 is a diagrammatic illustration of a further embodiment of a brewer as set forth in the present disclosure.

FIG. 4 is a diagrammatic illustration of yet another embodiment of a brewer as set forth in the present disclosure.

FIG. 5 is a diagrammatic illustration of yet a further embodiment of a brewer as set forth in the present disclosure.

### DETAILED DESCRIPTION

While the present disclosure may be susceptible to embodiment in different forms, there is shown in the drawings, and herein will be described in detail, embodiments with the understanding that the present description is to be considered an exemplification of the principals of the disclosure and is not intended to be exhaustive or to limit the disclosure to the details of construction and the arrangements of components set forth in the following description or illustrated in the drawings.

Terms including beverage, brewed, brewing, and brewed beverage as may be used herein are intended to be broadly defined as including, but not limited to the brewing or making of tea, coffee and any other beverages or food substances that will benefit from the present disclosure. This broad interpretation is also intended to include, but not be limited to, any process of dispensing, infusing, steeping, reconstituting, diluting, dissolving, saturating or passing a liquid through or otherwise mixing or combining a beverage substance with a liquid such as water without limitation to the temperature of such liquid unless specified. This broad interpretation is also intended to include, but is not limited to beverage substances such as ground coffee, tea, liquid beverage concentrate, powdered beverage concentrate, flaked, granular, freeze-dried or other forms of materials including liquid, gel, crystal or other form of beverage or food materials to obtain a desired beverage or food product. This broad interpretation is intended to include, without limitation, at least funnel and filter-type, packet or pouch-type, pod-type or other prepackaged or unpackaged forms of retaining and brewing a beverage or making of a food product. The terms heated water may be interpreted as hot water, and generally refers to adding energy to water to heat the water above ambient temperature.

While a “pod” is described herein, it is envisioned that any form of beverage brewing substance device, holder, filter structure or other substance delivery media or vehicle may be used. It is envisioned that the present apparatus, system and method of operation could be utilized with other concentrates such as freeze dried concentrates, gel, liquid, powder or any other form of concentrate which will operate with the disclosed apparatus, system and method as well as equivalents thereof and any modifications which might be required to modify the apparatus, system and method to be used with such other substances, if necessary. While the disclosure shows an illustration of a brewer that utilizes a pod, it is intended and understood that the term brewer is to be broadly interpreted to include brewers of any configuration including that as shown as well as, by way of example but not limitation, brewers that do not utilize pods. Pod brewers are brewers which retain a pod or prepackaged beverage product and deliver to or force water through the pod to brew a beverage. Many pod brewers produce one or two cups of beverage instead of 4-12 cups as is produced by many other brewers. Pod brewers may be configured consistent with the teachings of this disclosure to be connected to a pressurized water line and provide line pressure brewing. The teachings of this disclosure are intended to be broadly interpreted and applied to a variety of brewer sizes, styles and configurations consistent with the principals disclosed herein.

While the term “heated” may be used throughout this disclosure, the term is to be broadly interpreted to include all forms of water or dilution liquid of any temperature, generally in which the water has been heated. The term heated includes the term “hot” such that one might consider the water to be hot based on the numerical temperature. Generally, the temperature of the water is below or at the relevant boiling temperature (212 degrees F. at sea level) above which the water will generally transform to steam. The term heated is used to distinguish from the term unheated such that unheated water is generally introduced into the reservoir during the brewing cycle. In or near the reservoir the water is heated resulting in heated water.

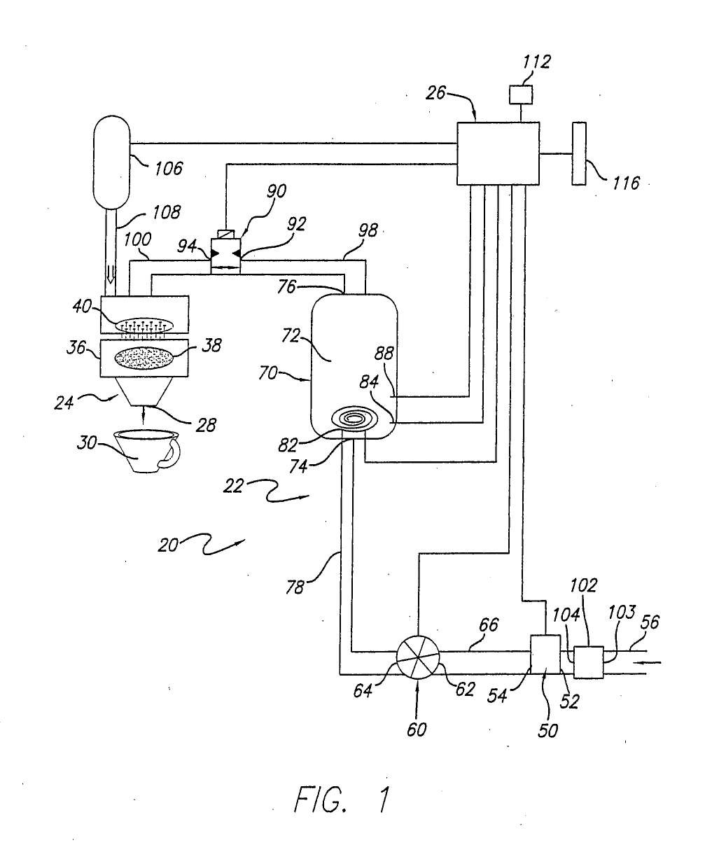

A brewer 20 is shown in FIG. 1. The brewer 20 includes a water delivery system 22, a brewing assembly 24 and a controller 26 that may include a microprocessor. The water delivery system 22 delivers water to the brewing assembly 24 by operation of the controller 26. The water delivered through the brewing assembly 24 produces a brewed beverage 28 that is dispensed to an associated container 30, such as a cup.

As shown in FIG. 1, the brewer 20 can be in the form of a single-serving pod brewer. The brewing assembly 24 includes a receptacle 36, such as a drawer that can be selectively opened and closed, adapted to removably receive a pod 38 of a brewing substance, such as coffee or tea. While the term pod is used in this description the term is to be broadly interpreted to include other forms of small portions of substances used for brewing. For example reusable single or small multiple serving substance holder may be used such as the loose coffee holders disclosed in co-pending applications assigned to the assignee of the present application. Those devices are disclosed in U.S. provisional application Nos. 60/560,033, filed Apr. 7, 2004, and 60/575,235, filed May 28, 2004, and 60/606,233, filed Sep. 1, 2004, and United States non-provisional application Ser. Nos. 11/101,321, filed Apr. 7, 2005, and 11/140,673, filed May 27, 2005, each of which are incorporated herein by reference in its entirety. The brewing assembly 24 also includes a spray head 40 having a plurality of apertures. The spray head 40 is adapted to direct water through the pod 38 of brewing substance to produce the brewed beverage 28. It should be noted that brewing relates to the preparation of coffee as well as tea and that the brewing assembly 24 may be used to brew a brewed beverage 28 such as coffee or tea, but may also be used to produce heated water for dispensing from the brewing assembly 24 into the cup 30 for subsequent use.

The water delivery system 22 includes a fluid pressure regulator 50 such as a pressure reducing/relieving valve. The pressure regulator 50 includes an inlet 52 and an outlet 54. The inlet 52 of the pressure regulator 50 is adapted to be placed in fluid communication with a standard potable water supply line 56 as is typically found in residences and offices. The water line 56 is a conduit containing pressurized water. The water in the water line 56 is typically pressurized in the range of twenty to ninety pounds per square inch (psi) of pressure. Water enters the inlet 52 of the pressure regulator 50 at a first pressure and exits the pressure regulator 50 through the outlet 54 at a second pressure which is lower than the first pressure of the water in the water line 56. The pressure of the water exiting the outlet 54 of the pressure regulator 50 may be in the range of ten to fifty pounds per square inch. The pressure regulator 50 may discharge water through the outlet 54 at a single selected pressure, or the pressure regulator may be selectively adjustable such that the pressure of the outflowing water may be selectively adjusted within a range of pressures such as from approximately ten psi to approximately thirty psi. The pressure regulator 50 may be electrically coupled to the controller 26 such that the controller 26 can control the pressure regulator 50 and thereby control the pressure of the water exiting the outlet 54 and flowing to the tank 70 and spray head 40. Alternatively, the pressure regulator 50 may be mechanically controlled, and not electrically coupled to the controller 26, and may for example, be a spring-loaded pressure regulator. The brewer in combination with the pod can produce a good cup of coffee in this pressure range. The water pressure range is well below the pressure of approximately 100 psi used in an espresso machine.

The water delivery system 22 also includes a fluid flow device 60 having an inlet 62 and an outlet 64. The inlet 62 of the flow device 60 is in fluid communication with the outlet 54 of the pressure regulator 50 and is coupled thereto by a fluid conduit 66. The outlet 64 of the fluid flow device 60 is in fluid communication with a fluid conduit 78 leading to the spray head 40. The fluid flow device 60 may comprise a flowmeter or a flow control. When the water delivery system 22 includes a flowmeter as the flow device 60, the flowmeter is adapted to sense and measure the flow rate of water, such as in cubic feet per minute, that is flowing through the conduit 66 and the flowmeter, and thereby through the spray head 40. The flowmeter is electrically coupled to the controller 26. The flowmeter transmits an electrical signal to the controller 26 that is indicative of the measured flow rate of water flowing through the flowmeter. The flowmeter indicates the flow rate of water flowing through the flowmeter and also when no water is flowing through the flowmeter. When the water delivery system 22 includes a flow control as the flow device 60, the flow control regulates the rate of flow at which water flows through the flow control and into the fluid conduit 78, such that water will flow through the fluid conduit 78, and thereby through the spray head 40, at a selected flow rate.

The water delivery system 22 also includes a tank 70 having a hollow chamber 72. The tank 70 includes an inlet 74 and an outlet 76, both of which are in fluid communication with the chamber 72. The tank inlet 74 is connected in fluid communication with the outlet 64 of the flow control 60 by a fluid conduit 78. The chamber 72 of the tank 70 is thereby in fluid communication with the flow device 60, pressure regulator 50 and the water line 56. A heating device 82 is associated with and may be located within the chamber 72 of the tank 70. The heating 82 device may be a resistance type of heating device having a heating element, or other types of heating devices. The heating device 82 is adapted to heat water within the tank 70 to a desired temperature that is suitable for use in brewing the beverage 28. The heating device 82 is electrically coupled to the controller 26 such that the controller 26 controls the operation of the heating device 82.

A temperature sensor 84 is also associated with the tank 70 and the chamber 72. The temperature sensor 84 is adapted to sense the temperature of the water within the chamber 72 of the tank 70. Temperature sensor 84 is electrically coupled to the controller 26 such that the temperature sensor 84 transmits an electrical signal to the controller 26 that is indicative of the water temperature sensed by the temperature sensor 84. The controller 26 controls the operation of the heating device 82 such as by cycling the heating device 82 “on” and “off”, and by controlling the operating temperature of the heating device 82 and the amount of heat output by the heating device 82 during operation.

The water delivery system 22 also includes an electrically actuated on/off dispensing valve 90 having an inlet 92 and an outlet 94. The inlet 92 of the valve 90 is in fluid communication with the outlet 76 and chamber 72 of the tank 70 through a fluid conduit 98 that extends therebetween. The valve 90 is thereby in continuous fluid communication with the chamber 72 of the tank 70, the flow device 60, pressure regulator 50 and water line 56. The outlet 94 of the valve 90 is in continuous fluid communication with the spray head 40 of the brewing assembly 24 through a fluid conduit 100. The valve 90 is selectively moveable between an “on” or open position and an “off” or closed position. When the valve 90 is in the “on” position the valve 90 allows the flow of heated water from the chamber 72 of the tank 70 to the spray head 40. When the valve 90 is in the “off” position, the valve 90 prevents the flow of heated water from the chamber 72 of the tank 70 to the spray head 40. The valve 90 is electrically coupled to the controller 26. The controller 26 is adapted to selectively control the operation of the valve 90 and the moving of the valve 90 between the “on” position and “off” position.

The water delivery system 22 may include a water level sensor 88 adapted to sense when the surface level of the water within the chamber 72 of the tank 70 is below a selected level such that the volume of water within the chamber 70 is below a corresponding volume. When the water level sensor 88 senses that the volume of water within the chamber 72 has fallen below the selected volume, the controller 26 prevents actuation of the heating device 82 to prevent damage to the components of the brewer 20. The water delivery system 22 may also include a one-way check valve 102 having an inlet 103 and outlet 104. The inlet 103 is in fluid communication with the water line 56 and the outlet 104 may be in fluid communication with the inlet 52 of the pressure regulator 50. The check valve 102 is adapted to prevent the outflow of water from the tank 70 through the inlet 74, while allowing water to flow from the water line 56 to the tank 70.

The brewer 20 may also include an air pump 106 that is in fluid communication with the spray head 40 through an air line 108. The air pump 106 is electrically coupled to the controller 26. In use, at the end of a brewing cycle, the controller 26 operates the air pump 106 to provide a purging volume, flow or pulse of air through the air line 108 and spray head 40. Air flowing through the air line 108 and spray head 40 purges water from the pod 38 and spray head 40 into the cup 30.

The brewer 20 may include one or more controls 112, such as a power switch for turning power to the brewer components on or off, and controls for manually initiating a brewing cycle, adjusting water temperature, adjusting pressure of water supplied by the pressure regulator 50, or adjusting the volume of water that flows through the spray head 40 in a brewing cycle. The brewer 20 may include a display 116 that provides visual indication of the general status of the brewer 20 including the status of the brewing cycle, water temperature and pressure, and the volume of water to be dispensed in a brewing cycle.

Further details of the configuration and operation of the single-serving brewer 20 can be found in related patent applications entitled “Apparatus, System and Method for Infusing a Pre-Packaged Pod (Atty. Docket No. 27726-95094) filed Feb. 9, 2004, U.S. Provisional Application No. 60/543,370, and U.S. application Ser. No. 11/055,411, filed Feb. 9, 2005, and “Apparatus System and Method for Retaining Beverage Brewing Substance” (Atty. Docket No. 27726-95093) filed Feb. 6, 2004, U.S. Provisional Application No. 60/542,433, and U.S. application Ser. No. 11/056,593, filed Feb. 7, 2005, and “Pod Brewer Design” (Atty. Docket No. 27726-95521) filed Feb. 10, 2004, and U.S. Design Application No. 29/199,168. Additional information relating to adjustable controlling of the single-serving brewer 20 can be found in a related provisional application entitled “Adjustable Volume Brewer” (Atty. Docket No. 27726-95059) filed Nov. 7, 2003, U.S. Provisional Application No. 60/518,039, and in Patent Cooperation Treaty Application No. US2004/037106, filed Nov. 5, 2004. Additional information related to a spray head system and method for delivering water to the brewing assembly of the single-serving brewer 20 can be found in U.S. Provisional Application entitled “Water Delivery System, Method and Apparatus” (Atty. Docket No. 27726-95058) filed Nov. 7, 2003, U.S. Provisional Application No. 60/518,411, and U.S. application Ser. No. 10/983,446, filed Nov. 8, 2004. Additional information related to beverage making apparatus which uses loose coffee and related devices and methods of use can be found in U.S. Provisional Application entitled “A Beverage Making Apparatus and Method Using Loose Beverage Substances” (Attorney Docket No. 27726-95865) filed Apr. 7, 2004, U.S. Provisional Application No. 60/560,033, and U.S. application Ser. No. 11/101,321, filed Apr. 7, 2005. Information about a pod holder with a removable insert can be found in U.S. Provisional Application entitled “Pod Holder with Removable Insert” (Attorney Docket No. 27726-96741) filed May 28, 2004, U.S. Provisional Application No. 60/575,235, and U.S. application Ser. No. 11/140,673, filed May 27, 2005. Information about a beverage making apparatus which uses loose coffee and related devices and methods of use can be found in US Provisional Application entitled “A Beverage Making Apparatus and Method Using Loose Beverage Substance” (Attorney Docket No. 27726-97275) filed Sep. 1, 2004, U.S. Provisional Application No. 60/606,233, and U.S. application Ser. No. 11/101,321, filed Apr. 7, 2005. Each of the above-referenced applications and the materials set forth therein is incorporated herein by reference in its entirety.

In use, the inlet 103 of the check valve 102 and the inlet 52 of the pressure regulator 50 are coupled in fluid communication with the pressured water line 56. If a variable pressure regulator 50 is used, it is coupled to the controller 26 and the pressure of the outflowing water may be selected by the user through the control 112. Water flows from the outlet 54 of the pressure regulator 50 through the conduit 66, flow device 60 and conduit 78 into the chamber 72 of the tank 70, and through the conduit 98 and valve 90, whereupon the valve 90 is closed. The conduits and the chamber 72 of the tank 70 are thereby filled with water at the selected pressure. The heating device 82 is then actuated to heat the water within the chamber 72 of the tank 70 to a selected temperature as monitored by the temperature sensor 84. The temperature of the heated water within the tank 72 can be selected by use of the control 112.

When a brewing cycle is to be initiated, the user places a pod 38 of brewing substance within the receptacle 36 of the brewing assembly 24. The user then actuates the control 112 whereupon the controller 26 moves the valve 90 to the open or on position. The pressurized water of the water line 56 forces water to flow through the pressure regulator 50 and forces water within the water delivery system 22 to flow through the flow device 60, and conduit 78 into the chamber 72 of the tank 70, whereupon the heated water in the tank 70 is forced through the conduit 98, valve 90 and conduit 100 to the spray head 40 at the selected pressure. The heated water flows through the spray head 40 and through the pod 38 of brewing substance to form the brewed beverage 28 that is dispensed into the cup 30. The pressurized water in this configuration is the primary motive force and reduces or eliminates the need for a pump. This is in contrast to a displacement-type brewer which merely displaces water from a tank. In the present disclosure the pressurized water is the primary force driving heated water through the system. The length of time the valve 90 is to be open to dispense a selected volume of heated water through the spray head 40 may be calculated based upon the flow rate of the water flowing through the valve 90 as determined by the flow device 60. Once the desired volume of heated water has been dispensed through the spray head 40 the controller 26 closes the valve 90 to thereby stop the flow of heated water from the chamber 72 of the tank 70 to the spray head 40. Once the valve 90 is closed, the air pump 106 may be activated by the controller 26 to purge water from the pod 38 and spray head 40. The pressure of the water in the water line 56 is thereby used to force water to flow through the water delivery system 22 and to supply water to the pod 38 through the spray head 40 at the selected pressure for brewing a beverage 28 with a desirable taste. The brewer 20 does not include any water pumps or other devices designed to pressurize the water within the water delivery system 22 for supply to the pod 38.

The control 112 can be used and programmed to function in conjunction with the controller 26 to vary the characteristics associated with the brewer 20. The control 112 may be used in conjunction with an appropriate program of the controller 26 to adjust the selected water pressure, water temperature, the quantity of water dispensed during a brew cycle, and the like.

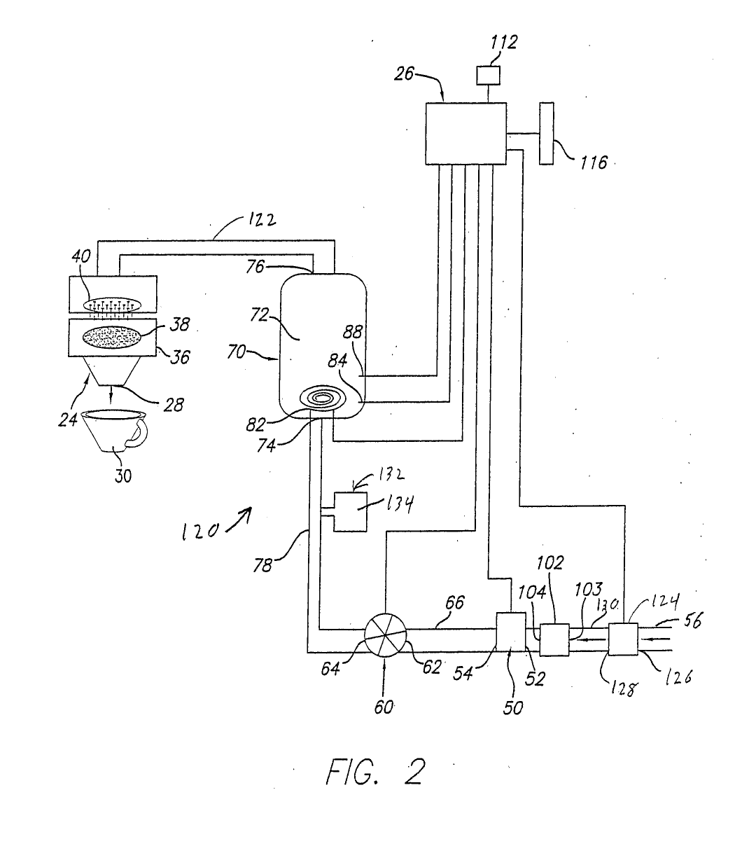

FIG. 2 shows another embodiment of the brewer of the present disclosure identified with the reference number 120. The brewer 120 as shown in FIG. 2 includes many of the same elements as the brewer 20 shown in FIG. 1, and like elements are identified with the same reference number. The brewer 120 does not include the dispensing valve 90 or the air pump 106 as shown in the brewer 20 of FIG. 1. In the brewer 120 the outlet 76 of the tank 70 is connected in fluid communication with the spray head 40 by a fluid conduit 122. The brewer 120 also includes an inlet valve 124 having an inlet 126 and an outlet 128. The inlet 126 of the inlet valve 124 is adapted to be coupled in fluid communication with the pressurized water line 56. The outlet 128 of the inlet valve 124 is coupled in fluid communication with the inlet 103 of the check valve 102 by a fluid conduit 130. The inlet valve 124 may be electrically coupled to the controller 26 such that the controller 26 can control the inlet valve 124 and selectively open or close the inlet valve 124. The inlet valve 124 may be moved between an open or “on” position wherein the inlet valve 124 permits water from the pressurized water line 56 to flow through the inlet valve 124 and into the chamber 72 of the tank 70. The inlet valve 124 may be selectively moved to the closed or “off” position wherein the inlet valve 124 will prevent water in the pressurized water line 56 from the flowing through the valve 124 to the tank 70. The inlet valve 124 of the brewer 120 will control the flow of water through the water delivery system of the brewer 120, either allowing or preventing the flow of water through the spray head 40.

The brewer 120 also includes an expansion accommodating system 132 including an expansion chamber 134. The expansion accommodating system 132 and expansion chamber 134 are described in U.S. Provisional Patent Application No. 60/617,105, filed Oct. 8, 2004, Patent Cooperation Treaty Application No. US2005/036386, filed Oct. 8, 2005, and U.S. patent application Ser. No. 11/275,271, filed Dec. 21, 2005 (Attorney Docket No. 27726-100955), which are incorporated herein by reference in their entirety. These applications are assigned to the assignee of the present application.

The expansion chamber 134 is in fluid communication with a venturi device which in turn further communicates in fluid communication with the fluid conduit 78. As water is heated in the chamber 72 of the tank 70 the volume of the water tends to expand within the chamber 72. As the water within the chamber 72 expands, water tends to flow through the outlet 76 and into the fluid conduit 122 which in turn may cause undesired dripping of water from the spray head 40. The expansion accommodating system 132 is provided to enable the water delivery system of the brewer 120 to operate under the pressure of the water entering the tank 70, and to accommodate the expansion of water which results in a closed system when newly introduced unheated water is added to the system, while eliminating dripping from the spray head 40 that may otherwise be caused by such expansion of the water. The expansion chamber 134 may be formed of silicone material such that the chamber is resiliently expandable and retractable.

The thermal expansion accommodating system 132 may alternatively include an expansion chamber 134 and an active expansion device coupled to the controller 26. The expansion chamber 134 communicates with the fluid conduit 78 at a position between the fluid flow device 60 and the tank 70. Water is generally introduced into the lower portion of the tank 70. This thermal expansion system differs from the system described above in that it is active whereas the other system is generally passive. This system is active in that it controllably creates an expansion volume whereas the prior system responsively creates an expansion volume. Generally, the passive system includes an expandable device or structure which expands and contracts in response to the pressure of expansion water, as described herein. The active system is controlled to create an expansion volume into which water can expand or be drawn to compensate for expansion.

The active expansion device is in the form of a device including but not limited to, a piston chamber, bellows, a controllable pressurized chamber, a pump controlled chamber, a controllably expandable bladder, or any other form of device which can be acted on to create an expansion space or otherwise draw water from the system to accommodate expansion water created during the heating of water (generally unheated) which is added to the tank 70. In the piston chamber embodiment, a piston is retained in communication with the fluid conduit 78 to draw water into the piston chamber thereby reducing the volume of water in the reservoir of the tank 70 and providing more room for water to expand in the reservoir. Similarly, a mechanically operated bellows embodiment can be operated to draw water from the reservoir. A separate chamber or expansion reservoir may include a controllable valve and an evacuation pump to controllably create a vacuum in the chamber to draw water from the inlet line into the chamber having the same result as noted above. All of the mentioned variations on this embodiment actively create a space, volume or otherwise draw water from the reservoir of the tank or inlet line to accommodate expansion water. The expansion or retained water may be held for return to the system on the next brew cycle or may be drained from the system.

The controller 26 may be programmed or otherwise controlled to operate the expansion device. The expansion device may be operated at the start of a brew cycle or at any time which provides the desired results for the expansion water. The expansion device may be controlled in response to expansion of the water in the reservoir of the tank so that the expansion is based on a measurable characteristic of the reservoir water. Alternatively, the expansion device may be operated a fixed amount to create a predefined volume into which water may expand or may draw a predetermined amount of water from the reservoir. If the expansion device is operated in response to a characteristic, the control may be based on the temperature of the water, the level of the water, the pressure of the water or any other measurable characteristic of the water in the reservoir of the tank 70. Also, these characteristics may be used to approximate or extrapolate the need to provide expansion volume or space based on an expansion model.

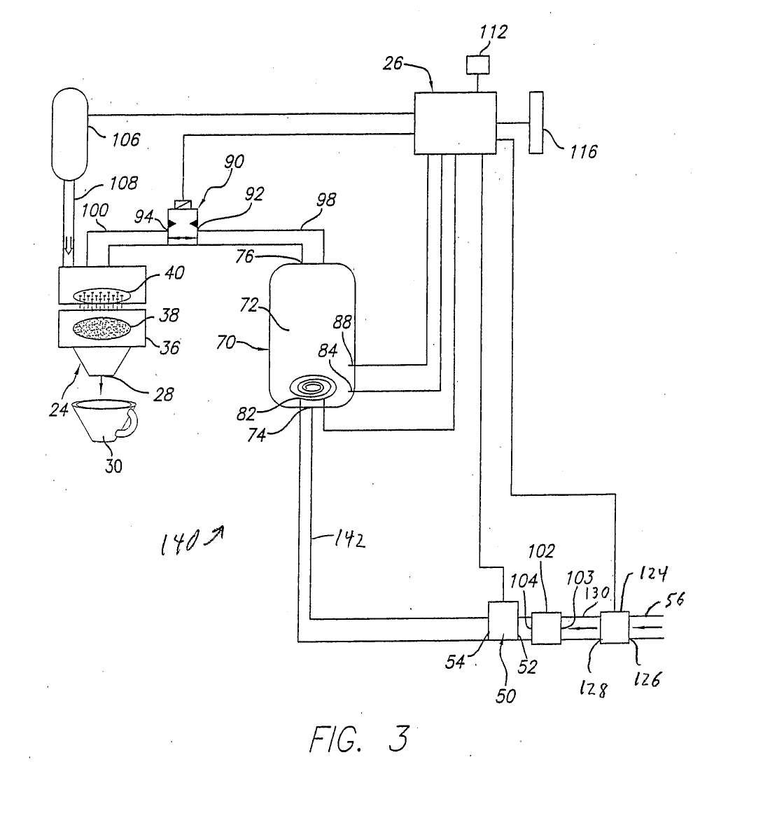

Another embodiment of the brewer of the present disclosure is shown in FIG. 3 and is identified with reference number 140. The brewer 140 includes many of the same elements as the brewers 20 and 120, and like elements are identified with the same reference number. The brewer 140 does not include the fluid flow device 60 as shown in the brewer 20 of FIG. 1. As opposed to the brewer 20 of FIG. 1, the brewer 140 includes an inlet valve 124 as does the brewer 120. In the brewer 140 the outlet 54 of the pressure regulator 50 is in fluid communication with the inlet 74 of the tank 70 through a fluid conduit 142. When the inlet valve 124 is open, the dispensing valve 90 will control the dispensing of water from the chamber 72 of the tank 70 through the spray head 40. When the inlet valve 124 is closed, the inlet valve 124 will prevent the flow of water from the pressurized water line 56 to the water delivery system of the brewer 140 and will prevent water in the chamber 72 of the tank 70 from flowing to the spray head 40 even when the dispensing valve 90 is open.

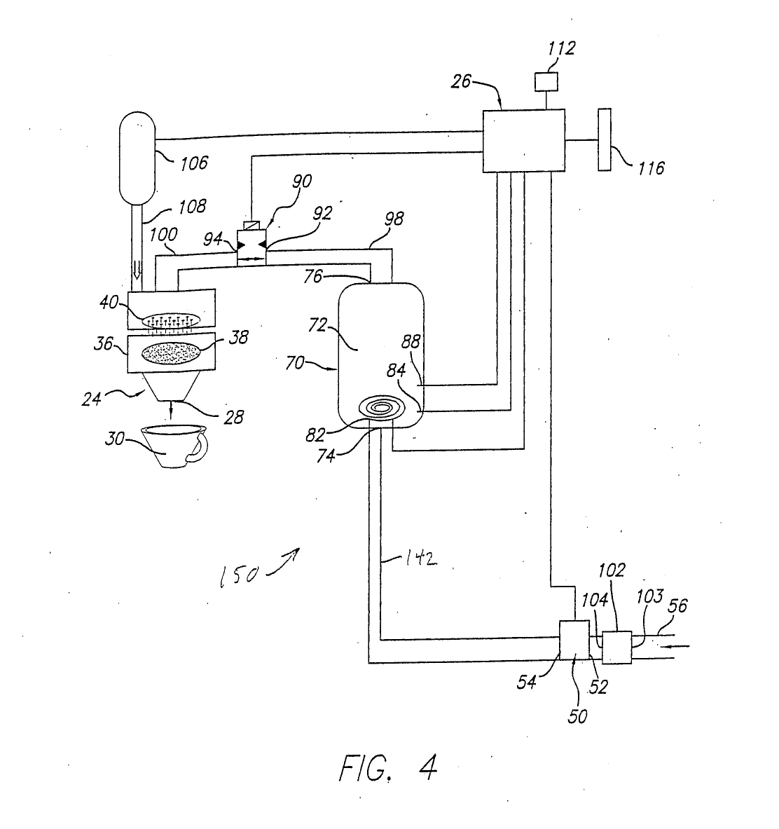

FIG. 4 shows another embodiment of the brewer of the present disclosure identified with the reference number 150. The brewer 150 includes many of the same elements as the brewer 20 of FIG. 1, and like elements are numbered with the same reference number. The brewer 150 does not include a fluid flow device 60 as shown in the brewer 20 of FIG. 1. Neither does the brewer 150 include an inlet valve 124 as does the brewer 140 of FIG. 3. The outlet 54 of the pressure regulator 50 is in fluid communication with the inlet 74 of the tank 70 through a fluid conduit 142. In the brewer 150, the flow of water from the pressurized water line 56 into the chamber 72 of the tank 70 is controlled by the dispensing valve 90. When the dispensing valve 90 is open, water from the pressurized water line 56 will flow into the tank 70, and water in the tank 70 will flow through the spray head 40. When the dispensing valve 90 is closed, water from the pressurized water line 56 will not flow into the tank 70, and water in the tank 70 will not flow through the spray head 40.

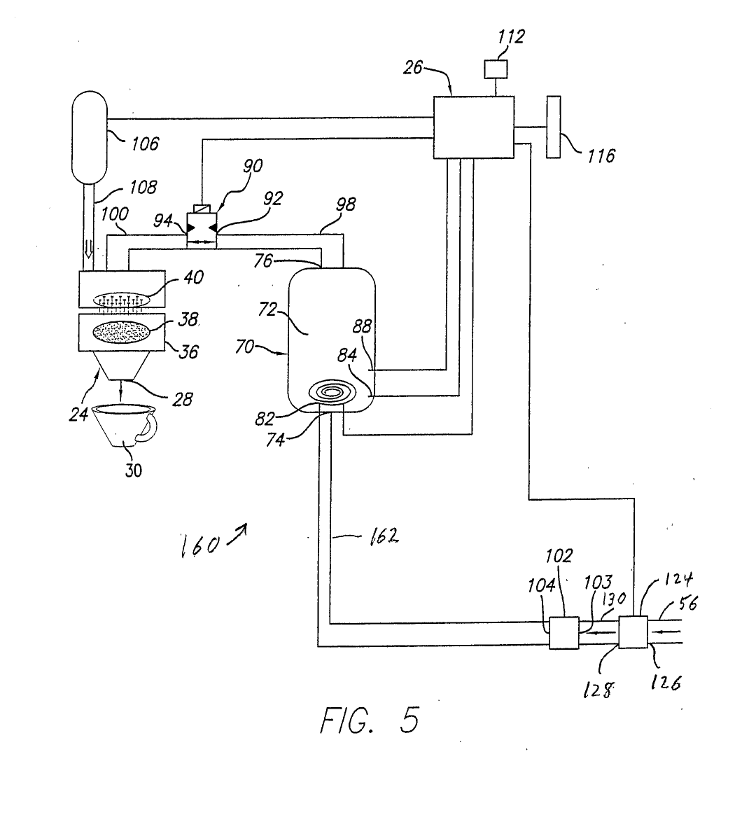

A further embodiment of the brewer of the present disclosure is shown in FIG. 5 and is identified with the reference number 160. The brewer 160 includes many of the same elements as the brewer 20 and like elements are identified with the same reference number. The brewer 160 does not include a fluid flow device 60 or a fluid pressure regulator 50 as does the brewer 20. The brewer 160 does include an inlet valve 124 coupled in fluid communication to the inlet 103 of the check valve 102. The brewer 160 includes a fluid conduit 162 that couples the outlet 104 of the check valve 102 in fluid communication with the inlet 74 of the tank 70. When the inlet valve 124 is open, the dispensing valve 90 will control the dispensing of water from the chamber 72 of the tank 70 through the spray head 40. When the inlet valve 124 is closed, the inlet valve 124 will prevent the flow of water from the pressurized water line 56 to the water delivery system of the brewer 140 and will prevent water in the chamber 72 of the tank 70 from flowing to the spray head 40 even when the dispensing valve 90 is open.

While embodiments have been illustrated and described in the drawings and foregoing description, such illustrations and descriptions are considered to be exemplary and not restrictive in character, it being understood that only illustrative embodiments have been shown and described and that all changes and modifications that come within the spirit of the invention are desired to be protected. The applicant has provided description and figures which are intended as an illustration of certain embodiments of the disclosure, and are not intended to be construed as containing or implying limitation of the disclosure to those embodiments. There are a plurality of advantages of the present disclosure arising from various features set forth in the description. It will be noted that alternative embodiments of the disclosure may not include all of the features described yet still benefit from at least some of the advantages of such features. Those of ordinary skill in the art may readily devise their own implementations of the disclosure and associated methods that incorporate one or more of the features of the disclosure and fall within the spirit and scope of the present disclosure.

What is claimed is:

1. A brewer for brewing a beverage adapted to be coupled to a pressurized water line, the brewer including:
a spray head adapted to discharge water for brewing a beverage;
a tank having a chamber adapted to be in fluid communication with the pressurized water line and in fluid communication with the spray head;
a fluid pressure regulator adapted to be in fluid communication with the pressurized water line and in fluid communication with the spray head, the regulator adapted to provide a flow of water from the regulator to the spray head at a selected pressure;
a dispensing valve adapted to be in fluid communication with the outlet of the tank and in fluid communication with the spray head, the dispensing valve adapted to selectively control the flow of water from the tank to the spray head;
whereby the dispensing valve is adapted to selectively allow water to flow from the tank to the spray head under pressure provided by the pressurized water line, such that the spray head discharges water for brewing a beverage.

2. The brewer of claim 1 including a heating device associated with the tank for heating water within the chamber of the tank.

3. The brewer of claim 1 including a flowmeter adapted to be in fluid communication with the pressurized water line and in fluid communication with the spray head, the flowmeter adapted to measure the rate of flow at which water flows to the spray head.

4. The brewer of claim 1 including a flow control device adapted to be in fluid communication with the pressurized water line and in fluid communication with the spray head, the flow control device adapted to regulate the rate of flow at which water flows to the spray head.

5. The brewer of claim 1 including a check valve adapted to be in fluid communication with the pressurized water line and in fluid communication with the tank, the check valve adapted to allow the flow of water from the pressurized water line to the chamber of the tank and to prevent the flow of water from the chamber of the tank through an inlet of the tank.

6. The brewer of claim 1 including an air pump in fluid communication with the spray head, the air pump adapted to provide a flow of air to the spray head to purge water from the spray head.

7. The brewer of claim 1 including a controller adapted to control operation of the brewer.

8. The brewer of claim 1 including a water level sensor associated with the tank, and a temperature sensor associated with the tank.

9. The brewer of claim 1 including a receptacle adapted to receive a quantity of brewing substance, the spray head adapted to discharge water into the receptacle to brew a beverage.

10. The brewer of claim 1 including an inlet valve adapted to be in fluid communication with the pressurized water line and in fluid communication with the tank, the inlet valve adapted to selectively allow water from the pressurized water line to flow to the chamber of the tank.

11. A brewer for brewing a beverage adapted to be coupled to a pressurized water line, the brewer including:
a tank having a chamber adapted to be in fluid communication with the pressurized water line;
a spray head in fluid communication with the tank and adapted to discharge water for brewing a beverage;
a fluid pressure regulator adapted to be in fluid communication with the pressurized water line and in fluid communication with the spray head, the regulator adapted to provide a flow of water from the regulator to the spray head at a selected pressure; and
a fluid flow device adapted to be in fluid communication with the pressurized water line and in fluid communication with the spray head, the fluid flow device determining the rate of flow at which water flows to the spray head;
whereby water is adapted to flow to the spray head for brewing a beverage under pressure provided by the pressurized water line.

12. The brewer of claim 11 wherein the fluid flow device comprises a flowmeter adapted to measure the rate of flow at which water flows to the spray head.

13. The brewer of claim 11 wherein the fluid flow device comprises a flow control device adapted to regulate the rate of flow at which water flows to the spray head.

14. The brewer of claim 11 including an inlet valve adapted to be in fluid communication with the pressurized water line and in fluid communication with the tank, the inlet valve adapted to selectively allow water to flow from the pressurized water line to the chamber of the tank.

15. The brewer of claim 11 including an expansion chamber in fluid communication with the chamber of the tank.

16. A brewer for brewing a beverage adapted to be coupled to a pressurized water line, the brewer including:
a tank having a chamber adapted to be in fluid communication with the pressurized water line;
a spray head in fluid communication with the tank and adapted to discharge water for brewing a beverage;
a dispensing valve in fluid communication with the spray head;
whereby the dispensing valve is adapted to selectively allow water to flow from the tank to the spray head under pressure provided by the pressurized water line, such that the spray head discharges water for brewing a beverage.

17. The brewer of claim 16 including an inlet valve adapted to be in fluid communication with the pressurized water line and in fluid communication with the chamber of the tank, the inlet valve adapted to selectively allow water to flow from the pressurized water line to the chamber of the tank.

18. A method of brewing a beverage with a brewer having a spray head in fluid communication with a tank, the method comprising the steps of;
coupling the tank in fluid communication with a pressurized water line;
flowing water from the pressurized water line to the tank under pressure provided by the pressurized water line;
flowing water from the tank to the spray head under pressure provided by the pressurized water line; and
dispensing water from the spray head for brewing a beverage.

19. The method of claim 18 including the step of heating the water in the tank.

20. The method of claim 18 including the step of controlling the pressure of the water that flows to the spray head.

21. The method of claim 18 including the step of controlling the flow rate of the water that flows to the spray head.

22. The method of claim 18 including the step of controlling the period of time the spray head dispenses water.
